(19) United States
(12) Patent Application Publication
(10) Pub. No.: US 2008/0247456 A1
(43) Pub. Date: Oct. 9, 2008

(54) System and Method For Providing Reduced Bandwidth Video in an Mhp or Ocap Broadcast System

(75) Inventor: Arjan Lemmers, Reek (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/088,184

(22) PCT Filed: Sep. 19, 2006
(86) PCT No.: PCT/IB2006/053375

§ 371 Date: Mar. 26, 2008

Related U.S. Application Data
(60) Provisional application No. 60/721,028, filed on Sep. 27, 2005.

(51) Int. Cl. H04N 11/02

(52) U.S. Cl. 375/240.01; 375/E07.026

(57) ABSTRACT

A system and method provides reduced bandwidth video in an MHP or OCAP broadcast system (100, 200). In one embodiment, the system and method provides end-users (viewers) (109) of an MHP or OCAP broadcast system (100) with a finite sequence of reduced bandwidth data images (133) sampled from a higher bandwidth video source (148). The finite sequence of reduced bandwidth data images (133) are preferably carried in a DVB signal stream (116) for a finite time duration to allow viewers (109) to view the data images (133) at their convenience. In another embodiment, the system and method provides end-users (viewers) (109) of an MHP or OCAP broadcast system (200) with a continuous stream of reduced bandwidth data images (233) sampled from a higher bandwidth digital video broadcast stream (150), preferably for use in a PIP display at the viewer's receiver (103).

The present invention is generally directed to a system and method for providing reduced bandwidth video in an MHP or OCAP broadcast system. More particularly, the invention is directed to providing end-users (viewers) of an MHP or OCAP broadcast system with a sequence of reduced bandwidth data images sampled from a higher bandwidth video source.

At present, specifications regarding environments for the execution of enhanced content on a broadcast receiving apparatus are being developed and operated in many areas. For example, a specification known as Digital Video Broadcasting-Multimedia Home Platform (DVB-MHP) has been laid out in Europe, and operation conforming to such specifications is already being initiated. Furthermore, a specification associated with the cable broadcasting environment, known as Open Cable Application Platform (OCAP), is being laid out in the United States, with operations scheduled to start in 2005. The digital video broadcasting (DVB) system is the worldwide standard for the digital broadcasting of video, audio and data. A digital video broadcasting—multimedia home platform (DVB-MHP) can be employed to support the digital broadcasting. DVB-MHP defines a generic interface between interactive digital applications and the terminals on which those applications execute. It enables digital content providers to address different types of terminals, including set-top boxes, integrated digital TV sets and multimedia PCs. The architecture of the MHP includes resources, system software and applications layers.

A digital receiver operating in accordance with the DVB-MHP (or OCAP) specification, receives a digital broadcast signal (e.g., an MPEG-2 data stream) that typically comprises video, audio and data components. If a viewer wishes to review a highlight from a previously transmitted video broadcast stream, for example, a replay of a goal in a soccer match, the broadcaster must retransmit that portion of the video stream. This is undesirable from the point of view of bandwidth consumption in that additional bandwidth is needed for the re-transmission. An associated drawback is the necessity of an additional signal-processing path to simultaneously decode the video highlight and the ‘normal’ video play-out.

It would therefore be desirable to allow a viewer to view previously broadcasted video sequences at a reduced bandwidth without the associated drawbacks of excessive bandwidth consumption and specialized hardware.

The disclosed embodiments provide systems and methods for providing reduced bandwidth video in an MHP or OCAP broadcast system. More particularly, a method and system is provided for sampling a video source at a broadcaster to derive a sequence of reduced bandwidth discrete data images. The data images are broadcasted over a communication medium to end-users (viewers) of the broadcast system for use in an iTV application running at a viewer's receiver. The sequence of reduced bandwidth discrete data images have a bandwidth transfer requirement that is significantly smaller than the segment of the video source from which the discrete data images were derived.

According to one aspect of the invention, a method for providing reduced bandwidth video in an MHP or OCAP broadcast system includes the acts of: sampling a video source to derive a sequence of data images, broadcasting the sequence of data images as part of a DVB transport stream over a communication medium to at least one receiver, and displaying the sequence of data images to a viewer upon request at the at least one receiver.

According to another aspect of the invention, a system for providing reduced bandwidth in an MHP or OCAP broadcast system includes: a broadcaster and at least one receiver configured to receive a signal stream transmitted therefrom. The broadcaster (101) comprises sampling means for sampling at least one video source to derive at least one sequence of data images, combining means for combining in the signal stream, selected ones of the at least one sequence of data images and at least one service stream, configuration means for selecting selected ones of the at least one sequence of data images to be transmitted to the at least one receiver and for managing the functions performed by the sampling means, transmitting means for transmitting the signal stream over the communication medium to the at least one receiver. The at least one receiver comprises: retrieving means for retrieving the signal stream over the communication medium, decoding means for decoding the at least one sequence of data images, displaying means for displaying the at least one sequence of data images to a viewer upon request. The system further comprises a data repository for maintaining the at least one sequence of data images and an iTV application encoded with processing instructions for implementing a method of managing the reception of reduced bandwidth video over a communications medium.

According to another aspect, a broadcaster supplying the sequence of data images may define various data image parameters including, for example, the image size, sample rate and a sample duration or time frame over which the sequence of discrete data images are to be sampled.

According to another aspect, supportable image formats for the sequence of discrete data images include, the PNG, GIF JPEG, and proprietary formats. The only restriction imposed on the selected image format is that it should be capable of being decoded at the viewer's receiver.

According to another aspect, a plurality of sequences of discrete data images may be generated a-priori to their actual use and maintained in a data repository for selection at a future time. The plurality of sequences of discrete data images may be sourced from any number of video sources, without limitation.

According to another aspect, the sequence of discrete data images may be transmitted in various embodiments as a non-repetitive stream or as a repetitive sequence of discrete data images in a carousel format. In an embodiment where the discrete data images are transmitted as a non-repetitive stream, the non-repetitive stream is preferably derived from a digital broadcast stream that is being broadcast from the broadcaster. An application that is well suited to this particular embodiment is a picture-in-picture (PIP) display. In a PIP application, the non-repetitive stream of discrete data images is used as a data source for the PIP display. The non-repetitive stream simulates the digital broadcast stream from which it was derived as a reduced bandwidth video approximation, suitable for broadcast in a DVB transport stream. In an alternative embodiment a sequence of discrete data images are transmitted repetitively in a DVB transport stream in a carousel format. This embodiment is ideally suited to an information application whereby viewers are afforded continuous access to the repetitive sequence of discrete data images for a finite time period as defined by the broadcaster.

The invention provides several advantages. One advantage of transmitting a sequence of discrete data images to the viewer over a communication medium is that a sequence of discrete data images consumes significantly less transmission bandwidth than the corresponding video signal segment from which it was derived. Another advantage is that, in one embodiment, the sequence of discrete data images are continuously broadcast in the digital video broadcast stream in the carousel format and are available to be viewed at the receiver at the convenience of the viewer. A further advantage of transmitting a sequence of sequence of discrete data images to the viewer is that no additional tuner/decoder is required to process the discrete data images. A still further advantage of transmitting a sequence of discrete data images to a viewer is that less storage is required than the corresponding video signal segment from which it was derived. As a consequence, the discrete data images are more easily cached at the receiver. A further advantage is that the system of the invention can be implemented on a standard MHP (or OCAP) set-top box without the need for special features.

The foregoing features of the present invention will become more readily apparent and may be understood by referring to the following detailed description of an illustrative embodiment of the present invention, taken in conjunction with the accompanying drawings, where

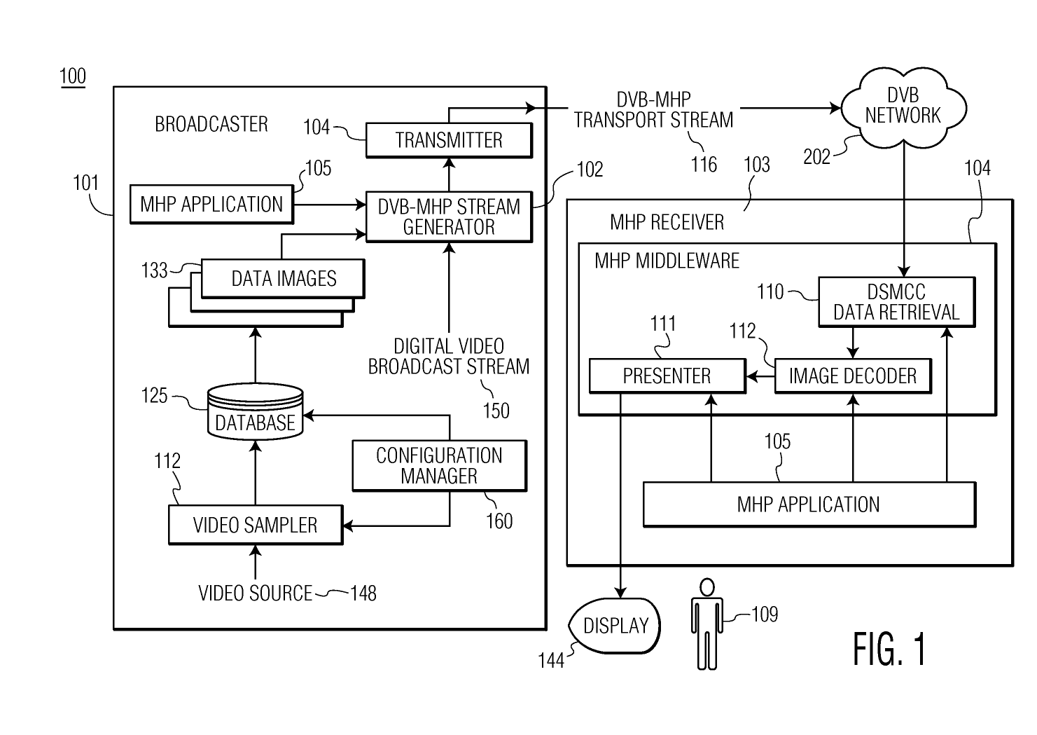

FIG. 1 illustrates a block diagram of a television broadcast system in which the system of the invention may be implemented, according to a first embodiment; and

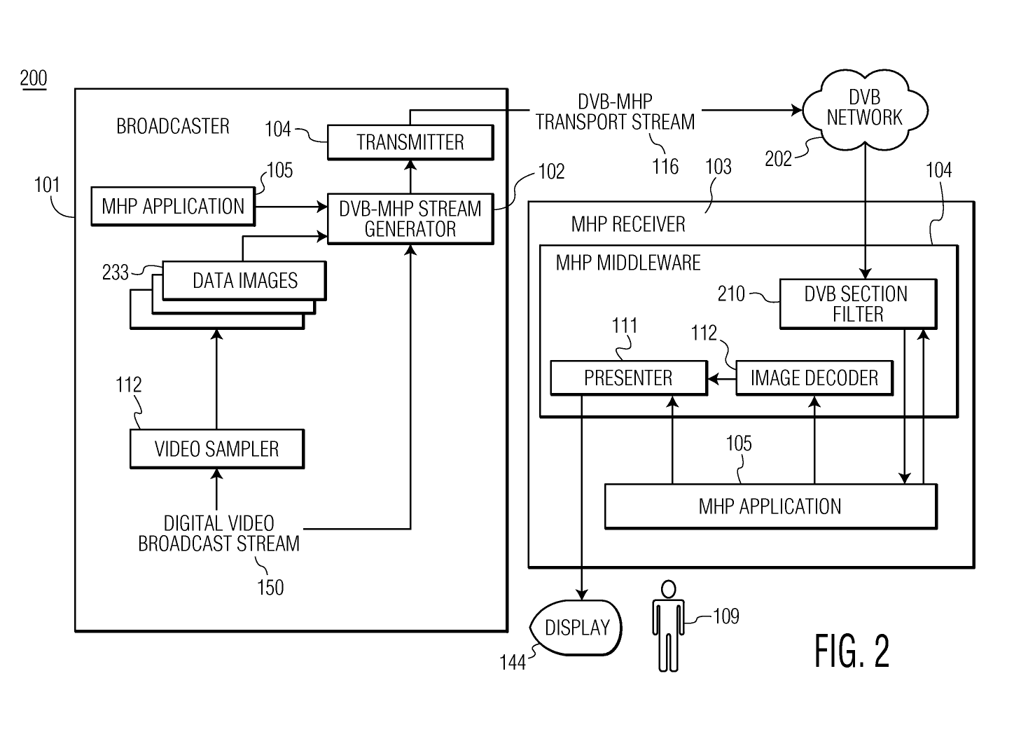

FIG. 2 illustrates a block diagram of a television broadcast system in which the system of the invention may be implemented, according to a second embodiment.

Although the following detailed description contains many specifics for the purpose of illustration, one of ordinary skill in the art will appreciate that many variations and alterations to the following description are within the scope of the invention. Accordingly, the following preferred embodiment of the invention is set forth without any loss of generality to, and without imposing limitations upon, the claimed invention.

FIG. 1 shows a block diagram of a TV broadcasting system 100 adapted to transmit TV audio and video data together with a sequence of discrete data images to a corresponding receiving system 103. The broadcast system 100 operates, by way of example and not limitation, in accordance with the DVB's MHP standard. It should be appreciated that the system and method of the invention is equally applicable to the OCAP standard which is the interactive TV standard for US cable networks, which is related to MHP, but is based on ATSC instead of DVB.

The TV broadcasting system 100 may be a satellite broadcasting system belonging to a commercial satellite broadcaster and the receiving system 103 may be one of many corresponding combinations of a satellite receiving dish and a set-top box for processing the received data for display on a display device 144. Equally, the broadcasting system 100 and corresponding receiving system 103 could be terrestrially based. In either case, the design, manufacturing and operation of such systems are well known and those parts which do not relate to the present invention will not be elaborated upon here further.

In such a transmission system, a broadcaster/server 101, referred to herein as a “Broadcaster” 101, includes a MHP DVB stream generator 102 arranged to multiplex at least three inputs into a DVB-MHP transport stream 116. The three inputs include (1) an MHP application 130, (2) a digital video broadcast stream 150 and (3) a sequence of discrete data images 133. It is noted that other inputs may be multiplexed into the DVB-MHP transport stream 116, however such inputs are outside the scope of the invention.

The MHP application 130 runs at the MHP receiver 103 and is an interactive MHP application (i.e., iTV application) configured to manage those operations associated with retrieving, decoding and displaying the sequence of discrete data images 133 received at the MHP receiver 116 from the broadcaster as one component of the DVB-MHP transport stream 116. It is worthy to note that while the MHP application 130 is described as being transmitted from the broadcaster 101 to the MHP receiver 103 in the present embodiment, it may be appreciated that, in an alternative embodiment, the MHP application 130 may be resident at the MHP receiver 103.

The digital video broadcast stream 150 is an MPEG-2 DVB compatible video stream 150 that uses the known MPEG-2-2 compression system to transmit compressed digital signals. One MPEG-2 DVB compatible video stream 150 is shown for simplicity. It should be appreciated, however, that multiple MPEG-2 DVB compatible video streams 150 may be used in a practical application.

The sequence of discrete data images 133 are analogous to an ‘animation sequence’. In other words, the discrete data images 133 represent a reduced bandwidth equivalent of a corresponding video sequence of a video clip or fragment (e.g., a goal scoring highlight event). By way of example, and not limitation, the discrete data images 133 may include, highlights from previously broadcast sporting contests, catastrophic events including, hurricanes and tsunamis, political events, such as, presidential elections political uprisings and so on.

A library of discrete data images 133 are stored in a data repository 125. The stored sequences may be sourced from any number of video sources 148. It should be understood that the data repository 125 may be included as part of the broadcaster 101 or instead be in communication with the broadcaster 101 and remotely located from the broadcaster 101. The multiple stored sequences of discrete data images 133 are preferably sampled well in advance of their eventual use.

One or more sequences of discrete data images 133 are output from the data repository 125 under control of the configuration manager 160, which determines which sequence or sequences are appropriate for inclusion in the DVB-MHP transport stream 116 at any point in time. It is to be appreciated that, depending upon the particular circumstances, multiple sequences of discrete data images 133 may be appropriate for use at any point in time. Conversely, circumstances may otherwise dictate the use of a single sequence of discrete data images 133.

The configuration manager 160 manages the selection of sequences of discrete data images 133. More particularly, the configuration manager 160 determines which of the stored sequences of discrete data images 133 are to be selected from the data repository 125 for inclusion in the DVB-MHP transport stream 116 at any point in time. One criteria for selecting a sequence of discrete data images 133 is the sequence's degree of correlation with a digital video broadcast stream 150 being broadcast. For example, the configuration manager 160 may select a particular sequence of discrete data images 133 that highlight great home run hitters of the past on the basis of its correlation to a digital video broadcast stream 150 that is broadcasting a baseball game including a player who is known to be a present day home run hitting icon. Alternatively, the configuration manager 160 may select a particular sequence of discrete data images 133 wholly independent of any digital video broadcast streams 150 that may be currently transmitted from the broadcaster 101.

It should also be appreciated that whichever one or more sequences of discrete data images 133 may be selected by the broadcaster for inclusion in the DVB-MHP transport stream 116, the selected sequences are made available to the viewer for a finite time (e.g., 10 minutes, 1 hour) as determined by the broadcaster 101. This feature overcomes a limitation of the prior art in that, previously a broadcaster re-transmitted a video sequence once at the convenience of the broadcaster 101. A viewer 109 who was not tuned to the re-transmission at the appropriate time would not be able to view the re-transmission.

In the present embodiment, the sequence of discrete data images 133 are transmitted from the broadcaster 101 to the plurality of MHP Receivers 103 in DSM-CC files in the broadcast file system. DSM-CC stands for “Digital Storage Media—Command.” The broadcast file system is transferred to the MHP/receiver 103 continuously, and repeatedly using a DSM-CC object (data) carousel mechanism. In alternative embodiments, the discrete data images 133 may be transmitted in the DVB-MHP transport stream 116 as a DSMCC stream event data field or in DVB tables and/or sections, as described below with reference to the second embodiment as illustrated in FIG. 2.

The sequence of discrete data image 133 may be generated at the broadcaster 101 in accordance with the present embodiment as follows. A video sampler 112, under control of the configuration manager 160, periodically samples a video source 148 (which can be any video source) to extract, for example, 12 frames per second of the video source 148 and converts each frame to a bit map file, preferably in the JPEG format. Other formats contemplated for use include, without limitation, PNG, GIF and proprietary formats. The conversion of each frame to a bit map file effectively constitutes a finite sequence of discrete data images 133.

The video sampler 122 utilizes a number of video extraction parameters to extract the sequence of discrete data images 133. They include an image size parameter, a sampling rate parameter and a video fragment length parameter. The parameters may be determined a-priori, i.e., during system configuration and may be changed afterward. Each of the extraction parameters are described as follows.

The image size parameter determines the resolution size in pixels of each discrete data image 133 extracted from the digital video broadcast stream 150. There is no restriction on the particular value chosen for this parameter, however, a typical image size is on the order of (720×576) as it corresponds to the MHP screen size. Those skilled in the art will recognize that Image sizes smaller than (25×25) are impractical in that they do not yield a recognizable screen output. Those skilled in the art will also recognize that the MHP application 130 can scale images as needed for display.

The sampling rate parameter determines the rate at which a sequence of discrete data images 133 are sampled from the digital video broadcast stream 150. The sampling rate parameter preferably ranges substantially from 30 frames/sec up to 30 seconds/frame.

The video fragment length parameter establishes the time frame (i.e., start and stop time) for the entire sequence of discrete data images to be extracted from the digital video broadcast stream 150. The video fragment length parameter preferably ranges substantially from a few seconds up to two or more hours. The video fragment length is only limited by the amount of bandwidth that the broadcaster 101 is willing to allocate.

The DVB-MHP transport stream 116 is broadcast from a transmitter 104 over a unidirectional DVB broadcast network 200 to a plurality of MHP receivers within the MHP broadcast system, one of which is shown for ease of explanation, i.e., MHP receiver 103.

The DVB-MHP transport stream 116 is received over DVB network 202 at substantially all MHP receivers 103 in the broadcast system. As shown in FIG. 1, MHP receiver 103 comprises MHP middleware 104 including a DSM-CC data retrieval module 110, a decoder module 112 and a presenter 111. The MHP middleware 104 is configured to run the MHP application 130 configured to manage operations associated with retrieving the sequence of discrete data images 133 from the DVB-MHP transport stream 116, decoding the sequence of discrete data images 133 and presenting the decoded sequence of discrete data images 135 to a viewer 190 upon request. The MHP application 130 is preferably broadcast in a carousel format from the broadcaster 101 as part of the DVB-MHP transport stream 116 and may be downloaded for use by any MHP receiver 103 in the network.

Under control of the MHP application 105, the DSM-CC data retrieval module 110 reconstructs the DSMCC file-system (including file content) from the DVB-MHP transport stream 116. The file content of the DVB-MHP transport stream 116 includes the sequence of discrete data images 133. When a DSMCC file becomes available, the MHP application 105 passes the sequence of discrete data images 133, contained in the DSMCC file to the image decoder 112 for decoding. The decoded sequence of discrete data images 135 are available be displayed on an appropriate display device 144, at the request of the viewer 109. When a request is made by a viewer to display the sequence of decoded discrete data images 133, the MHP application 105 instructs the presenter 111 to display the sequence of discrete data images 133 as a smoothly running ‘animation sequence’. It should be noted that the operations of retrieval and image decoding, as described, may be performed well in advance of a viewer request to display the sequence of discrete data images 133. It is to be appreciated that when such operations are performed well in advance, the sequence of discrete data images 133 can be displayed to a viewer 109 without delay.

In a second embodiment, as illustrated in FIG. 2, a digital video broadcast stream 150 is continuously sampled at the broadcaster 101, from which a continuous non-repeating discrete data image stream 233 is generated. This is in contrast to the previously described embodiment, as illustrated in FIG. 1, in which a finite sequence of discrete data images 133 are transmitted from the broadcaster 101 for a prescribe period of time (e.g., 10 minutes, 1 hour). In the present embodiment, the continuous stream of discrete data images 233 are transmitted in real-time from the broadcaster 101 to the plurality of MHP Receivers 103 in DVB sections in the broadcast file system 200. As is well known to those knowledgeable in the communication arts, an image file may be broken up into constituent blocks of 4K or less, each block being commonly referred to as a DVB container. Additional information is typically added to each DVB container to facilitate reconstruction of the discrete data image at the receiver 103. The additional fields may include, for example, fields such as a timestamp field.

In operation, a viewer 109 watching a live video broadcast on a particular service being carried as part of the DVB-MHP transport stream 116, may choose to initiate a PIP display while watching the live video broadcast. In response to the viewer 109 choosing to initiate a PIP display on the display screen 144, the MHP application 130 begins to filter the DVB sections carrying the non-repeating stream of discrete data images 233, transmitted as part of the DVB-MHP transport stream 116. Filtered DVB sections arrive on a periodic basis at the MHP application 130. The DVB sections are combined at the MHP application 130. At a point in time when a complete image is constructed, the image is forwarded to the image decoder 112 to be decoded for display by the presenter 111 at the correct moment in time to create a continuous streams of discrete data images 233 (e.g., an ‘animated sequence’). It should be appreciated from the description that the operations of filtering, decoding and displaying are executed substantially simultaneously to ensure a continuous display of discrete data images 233.

It should be appreciated that in various embodiments, the broadcaster has the option of sampling a number of video streams of the broadcaster's choosing to create one or more continuous streams of discrete data images 233. It should be appreciated that FIG. 2 illustrates a single continuous stream of discrete data images 233 for simplicity.

Generally, a broadcaster 101 can choose to sample any number of digital broadcast channels of a particular broadcast stream, (e.g.,channels 1 through 5) for inclusion in the DVB-MHP transport stream 116. In so doing, the viewer 109 has the option of selecting, in real time, any of the sampled channels 1 through 5, in a PIP display at the viewer's display 144. Initiating a PIP display of channel 1, for example, would result in the viewer being shown an ‘animated sequence’ of discrete data images of channel 1.

Finally, it should be appreciated that the present invention is not constrained to television systems but could be applied to any data broadcast system, based, for instance, on MPEG streams, such as DAB (Digital Audio Broadcasting) digital radio or custom broadcast applications.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or functions;

e) any of the disclosed elements may be comprised of hardware portions (e.g., including and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A method for providing reduced bandwidth video in a broadcast system (100) includes the acts of:
(a) sampling a video source (148) for a prescribed time to derive a finite sequence of discrete data images (133),
(b) broadcasting the finite sequence of discrete data images (133) as part of a signal stream (116), for a finite time, over a communication medium (202), to at least one receiver (103), and
(c) displaying the finite sequence of discrete data images (133) to a viewer (109) responsive to a viewer (109) request at the at least one receiver (103).

2. The method of claim 1, wherein prior to said act (b), the method further comprises the acts of:
encoding the finite sequence of discrete data images (133), and
multiplexing the encoded finite sequence of discrete data images (133) in the DVB signal stream (116).

3. The method of claim 2, wherein the sequence of data images (133) are multiplexed in the signal stream (116) in a carousel format.

4. The method of claim 1, further comprising multiplexing an application (105) into the DVB signal stream (116).

5. The method of claim 2, wherein subsequent to said act (c) of displaying, the method further comprises the acts of:
retrieving the encoded finite sequence of data images (133) from the DVB signal stream (116) at the at least one receiver (103), and
decoding the encoded sequence of data images (133, 233) from the DVB signal stream (116) at the at least one receiver (103).

6. The method of claim 1, wherein the broadcast system (100) is one of an MHP and an OCAP broadcast system (100).

7. The method of claim 1, further comprising the act of storing the sequence of data images (133) in a data repository (125), prior to said act (b) of broadcasting.

8. The method of claim 1, wherein the finite sequence of data images (133) is multiplexed into the DVB signal stream (116) as a one or more DSMCC files.

9. A method for providing reduced bandwidth video in a broadcast system (200) includes the acts of:
(a) sampling a digital video broadcast stream (150) to derive a continuous stream of discrete data images (233),
(b) broadcasting the continuous stream of discrete data images (233) in a DVB signal stream (116) over a communication medium (202), to at least one receiver (103), and
(c) displaying the continuous stream of discrete data images (233) to a viewer (109), responsive to a viewer (109) request at the at least one receiver (103).

10. The method of claim 9, wherein prior to said act (b), the method further comprises the acts of:
encoding the continuous stream of discrete data images (233), and
multiplexing the encoded continuous stream of discrete data images (233) in the DVB signal stream (116).

11. The method of claim 9, wherein subsequent to said act (c) of displaying, the method further comprises the acts of:
retrieving the encoded finite sequence of discrete data images (133) from the DVB signal stream (116) at the at least one receiver (103), and
decoding the encoded sequence of discrete data images (133, 233) from the DVB signal stream (116) at the at least one receiver (103).

12. The method of claim 9, further comprising multiplexing an application (105) into the DVB signal stream (116).

13. The method of claim 9, wherein the broadcast system (200) is one of an MHP and an OCAP broadcast system (200).

14. The method of claim 9, wherein the continuous stream of discrete data images (133) is multiplexed into the DVB signal stream (116) in DVB sections.

15. The method of claim 9, wherein the continuous stream of discrete data images (233) are sampled in real-time.

16. The method of claim 9, wherein said act (c) of displaying further comprises displaying the continuous stream of discrete data images (233) to a viewer (109) in a picture-in-picture display format on a display device (144) of the viewer (109).

17. A system for providing reduced bandwidth video over a communications medium (202) for use in a broadcast system (100, 200), the system comprising a broadcaster (101) and at least one receiver (103) configured to receive a signal stream (116) transmitted therefrom, wherein the broadcaster (101) comprises:
sampling means (112) for sampling at least one video source (148) to derive at least one sequence of data images (133),
combining means (102) for combining in said signal stream (116), selected ones of said at least one sequence of data images (133) and at least one service stream (150),
configuration means (160) for selecting selected ones of said at least one sequence of data images (133) to be transmitted to the at least one receiver (103) and for managing the functions performed by the sampling means (112),
transmitting means (104) for transmitting the signal stream (116) over the communication medium (202) to the at least one receiver (103),
wherein the at least one receiver (103) comprises:
retrieving means (110, 210) for retrieving the signal stream (116) over said communication medium (202),
decoding means (112) for decoding the at least one sequence of data images (133),
displaying means (111) for displaying the at least one sequence of data images (133) to a viewer upon request.

18. The system of claim 17, wherein the broadcaster (101) further comprises a data repository (125) for maintaining the at least one sequence of data images (133).

19. The system of claim 17, wherein the broadcast system (100, 200) is a satellite broadcast system.

20. The system of claim 17, wherein the broadcast system (100, 200) is a terrestrially based broadcast system.

21. The system of claim 17, wherein said combining means (102) further combines an application (105) into said DVB signal stream (116).

22. The system of claim 17, wherein said application (105) is broadcast in a carousel format broadcast from said broadcaster (101) in said DVB signal stream (116).

23. The system of claim 17, wherein the DVB signal stream (116) is a DVB-MHP signal stream (116).

24. The system of claim 17, wherein the at least one sequence of data images (133) is combined by said combining means (102) in the DVB signal stream (116) as a DVB section.

25. The system of claim 17, wherein the at least one sequence of data images (133) is combined by said combining means (102) in said signal stream (116) as one or more DSMCC files.

26. The system of claim 17, wherein the plurality of sequences of data images (133) are stored in a format selected from the group consisting of PNG, GIF JPEG, and a proprietary format.

27. A computer-readable medium (105) encoded with processing instructions for implementing a method of managing the reception of reduced bandwidth video over a communications medium (202) the method including the acts of: managing retrieving means (110, 210) for retrieving a signal stream (116) over the communication medium (202), managing decoding means (112) for decoding at least one sequence of data images (133) and managing displaying means (111) for displaying the at least one sequence of data images (133) to a viewer upon request.
